(19) United States
(12) Patent Application Publication
(10) Pub. No.: US 2003/0009462 A1
(43) Pub. Date: Jan. 9, 2003

(54) Computer-readable designators and methods and systems of using the same

(76) Inventor: Guy L. Burnham, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/898,792

(22) Filed: Jul. 3, 2001

(51) Int. Cl. G06F 7/00

(52) U.S. Cl. 707/10

(57) ABSTRACT

Methods and systems for accessing network-accessible resources are described. In but one embodiment, a system comprises a readable resource, a human-readable resource designator on the readable resource, and a computer-readable resource designator on the readable resource. The computer-readable resource designator is associated with and corresponds to the human-readable resource designator. The computer-readable resource designator is configured for use by a computer so that a computer can automatically retrieve a resource associated with both the human-readable resource designator and the computer-readable resource designator.

### TECHNICAL FIELD

This invention relates to methods and systems for accessing network-accessible resources.

### BACKGROUND

The advent and continuing development of computers and computer networks has facilitated the storage, management and retrieval of network-accessible resources. One type of network-accessible resource is a Web page that can be accessed via a network such as the Internet. Web pages can be used in a variety of different ways. For example, a user browsing the Web may find a particular Web page that contains information of interest. Accordingly, the user can print the Web page so that they can have a tangible, readable resource in the form of a printed piece of paper.

Web pages are accessed by, and typically list when printed, what is known as a Universal Resource Locator or “URL”. A URL is a text string that describes the address of a file (i.e. resource) that is accessible on the Internet. The type of resource depends on the Internet application protocol. Using the World Wide Web's (WWW) protocol, the Hypertext Transfer Protocol, the resource can be an HTML page, an image file, a program such as a common gateway interface (CGI) application or Java applet, or any other file supported by HTTP. The URL contains the name of the protocol required to access the resource, a domain name that identifies a specific computer on the Internet, and a hierarchical description of a file location on the computer.

On the Web (which uses the Hypertext Transfer Protocol), an example of a URL is:

http://www.mhrcc.org/kingston

which describes a Web page to be accessed with an HTTP (Web browser) application that is located on a computer named www.mhrcc.org. The specific file is in the directory named /kingston and is the default page in that directory.

An HTTP URL can be for any Web page, not just a home page, or any individual file. For example, this URL would bring you the whatis.com logo image:

http://whatis.com/whatisAnim2.gif

A URL for a program such as a forms-handling common gateway interface script written in Practical Extraction and Reporting Language might look like this:

http://whatis.com/cgi-bin/comments.pl

A URL for a file meant to be downloaded would require that the “ftp” protocol be specified like this one:

ftp://www.somecompany.com/whitepapers/widgets.ps

As an example of a printed Web page, consider FIG. 1 which shows a Web page 100 that is associated with the assignee of this document. When printed, Web pages typically contain headers or footers that can include the URL that is associated with the Web page. In this example, Web page 100 includes a footer 102 that contains the URL of the Web page. As of the date that this Web page was printed (i.e. Apr. 30, 2001), this was the most current, up-to-date version of the Web page. As many Web pages often do change in content, five or ten days from now the printed version of Web page 100 may be obsolete. Thus, there exists an unsolved need associated with maintaining synchrony between printed or human readable Web resources such as Web pages and the most current version of the resources.

Consider additionally another circumstance associated with printed Web pages. Specifically, Web pages often contain far more information that can be gleaned from the printed version of the Web page. For example, there may be audio files, video files, differently-formatted files (i.e. files in other languages and the like) that are all associated with the Web page. If the user desires to access this other information, they will necessarily need to access a Web browser and physically input the URL associated with the printed Web page by hand. This can be tedious and time-consuming for the user.

Accordingly, this invention arose out of concerns associated with providing systems and methods for automatically accessing network-accessible resources.

### SUMMARY

Methods and systems for accessing network-accessible resources are described.

In one embodiment, a readable resource is provided. A human-readable resource designator is defined that can be used to access information associated with the readable resource. A computer-readable resource designator is defined that can be used by a computer to automatically access the information associated with the readable resource. The human-readable resource designator and the computer-readable resource designator are then associated on the readable resource.

In another embodiment, a computer-readable resource designator is read by a computer and is used by the computer to automatically access information. The computer-readable resource designator is displayed on a readable resource and is displayed in conjunction with a human-readable resource designator that can be read by a human and used to access the information. The computer-readable resource designator is processed to identify a designator that is associated with a network-accessible resource. A designated resource can then be requested and received.

In another embodiment, a system comprises a readable resource, a human-readable resource designator on the readable resource, and a computer-readable resource designator on the readable resource. The computer-readable resource designator is associated with and corresponds to the human-readable resource designator. The computer-readable resource designator is configured for use by a computer so that a computer can automatically retrieve a resource associated with both the human-readable resource designator and the computer-readable resource designator.

### BRIEF DESCRIPTION OF THE DRAWINGS

The same numbers are used throughout the drawings to reference like features and components.

FIG. 1 is an illustration of a Web page in accordance with the prior art.

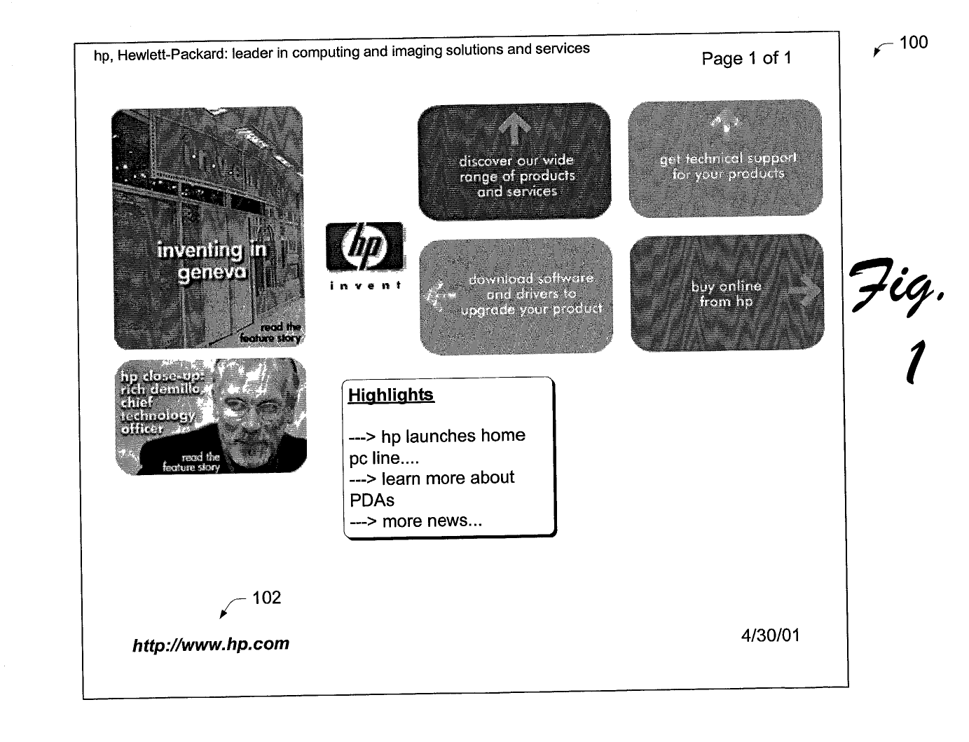

FIG. 2 is a diagram of an exemplary readable resource configured with resource designators in accordance with one embodiment.

FIG. 3 is an illustration of a readable resource in the form of a Web page that is configured with resource designators in accordance with one embodiment.

FIG. 4 is a diagram of an exemplary integrated resource designator that includes both a human-readable component and a computer-readable component in accordance with one embodiment.

FIG. 5 is an illustration of a readable resource in the form of a Web page that is configured with a resource designator of FIG. 4.

FIG. 6 is a flow diagram that describes steps in a method in accordance with one embodiment.

FIG. 7 is a block diagram of an exemplary system in accordance with one embodiment.

FIG. 8 is a flow diagram that describes steps in a method in accordance with one embodiment.

### DETAILED DESCRIPTION

Overview

Methods and systems for using computer-readable designators are described. In some embodiments, text strings or designators such as URLs, which are human-readable and which are typically associated with network-accessible resources, are associated with computer-readable designators. The computer-readable designators are provided so that, among other things, the computer-readable designators can be automatically read by suitably configured computers such as various types of computing devices such as printers, lap top computers, hand held computing devices (e.g. personal digital assistants) and the like. By automatically reading the computer-readable designators, the computers or computing devices can then take steps to access the associated network-accessible resource automatically. The resource can then be used for any number of purposes by the computing device or user. For example, the obtained resource can be used to synchronize a so-called readable resource with a most current version of the resource. Alternately or perhaps additionally, the resource can be used to access further information associated with the resource to provide a robust user experience. Such will become more apparent as the description below is read.

Exemplary Embodiment

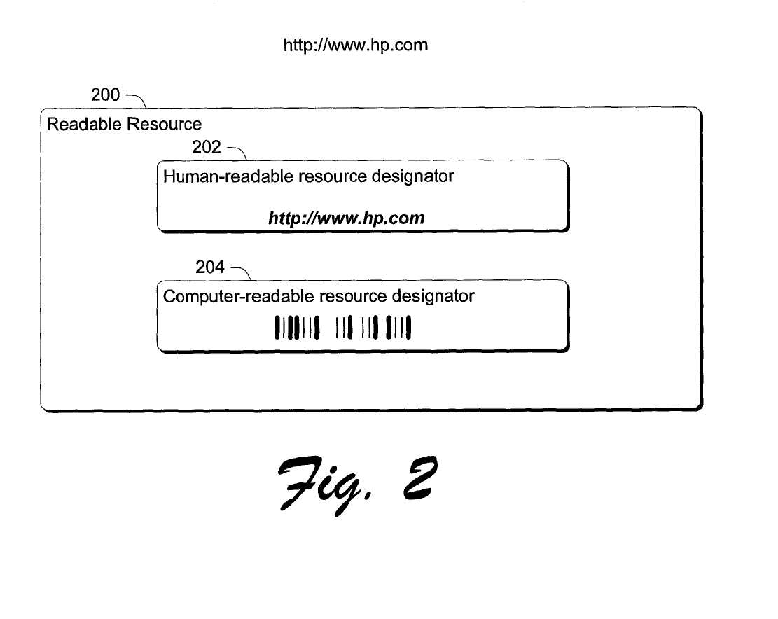

FIG. 2 shows an exemplary readable resource 200 that contains a human-readable resource designator 202 and a computer-readable resource designator 204 in accordance with one embodiment. It is to be appreciated and understood that any suitable readable resource can be used. In the present example, the readable resource can comprise a printed piece of paper upon which the described designators appear. Such readable resource need not, however, comprise a printed piece of paper, but rather, can comprise any human-readable resource. Such resources can include, without limitation, placards, signs, billboards, or media of any type that is capable of supporting human-readable text thereon.

In addition, the human-readable resource designator 202 can comprise any suitable human-readable resource designator. In the present example, the human-readable resource designator 202 just so happens to comprise a URL. But such need not, however, be the case. Thus, in this example, readable resource 200 comprises a printed document and human-readable resource designator 202 comprises a URL that is printed on the document. In addition to containing the human-readable resource designator 202, readable resource 200 also includes a computer-readable resource designator 204. The computer-readable resource designator 204 can comprise any type of designator that can be automatically read by a suitably configured computing device. In this specific example, the computer-readable resource designator 204 just so happens to comprise a series of scan lines that can be suitably scanned by an appropriate scanner. The scan lines are similar to and can comprise scannable bar code symbols. In addition, the computer-readable resource designator can comprise one that is not readable by a human for purpose of accessing the information with which it is associated.

The computer-readable resource designator desirably corresponds to its associated human-readable resource designator such that when the computer-readable resource designator is read by a suitably configured computing device, the computing device can, in some embodiments, automatically access or cause the access of the resource that is referenced by the human-readable resource designator.

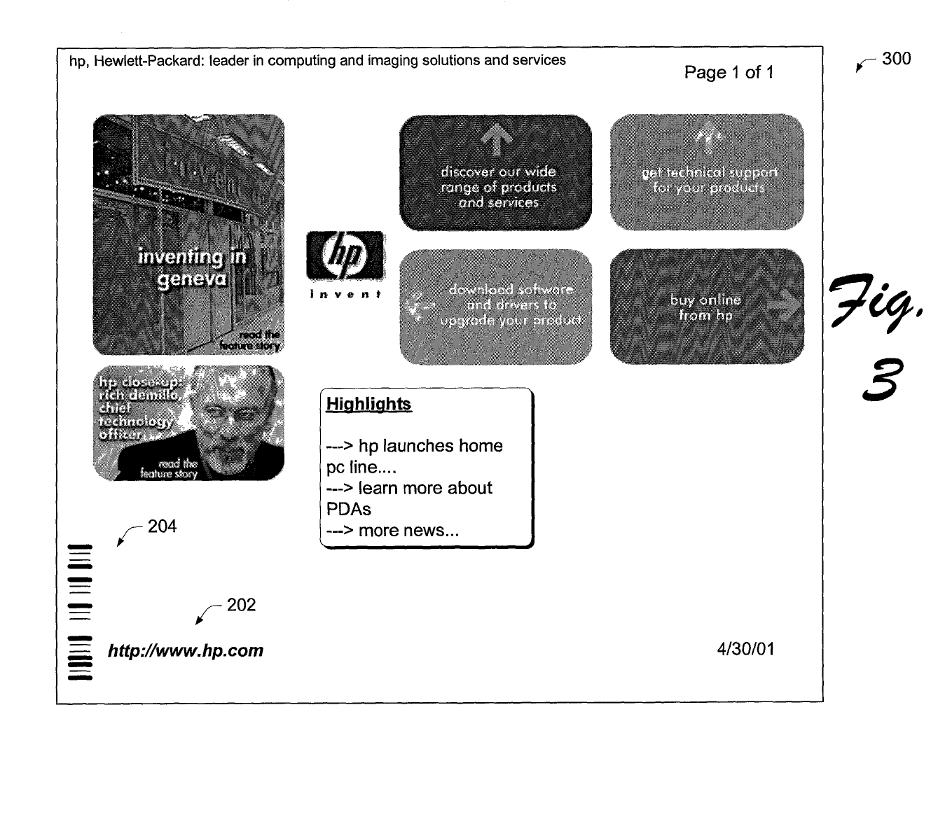

FIG. 3 shows a readable resource embodied as a printed Web page 300. The Web page includes both a human-readable resource designator 202 and a computer-readable resource designator 204. In this example, the human-readable resource designator 202 appears at the bottom left portion of the Web page. The computer-readable resource designator 204 appears along the left margin of the Web page 300. As an aside, it is to be appreciated that mechanisms can be put in place that see to it that the computer-readable resource designator for a particular page is not confused with other computer-readable designators that might appear on the page. For example, consider a primary Web page that itself has images of other secondary Web pages. If each of the secondary Web pages has an associated visible computer-readable resource designator, then it is conceivable that a scanner might inadvertently scan one of the designators appearing on a secondary Web page, rather than scanning the designator of the primary Web page. To alleviate concerns associated with this type of situation, the computer-readable resource designators can be placed in standard locations on a Web page. Thus, scanners can be programmed to look at these standard locations when searching for a scannable designator. Alternately, the computer-readable resource designator can be encoded with data that is uniquely associated with the Web page itself. For example, a checksum or hash of some type might be computed for a Web page and then encoded in the computer-readable resource designator. When a scanner detects more than one computer-readable resource designator on a Web page, it can re-compute the checksum or hash for the page, and then select the designator with a corresponding encoded checksum or hash.

In the examples of FIGS. 2 and 3, the human-readable resource designator 202 and the computer-readable resource designator 204 appear as separate elements that are not necessarily integrated. In some embodiments, however, the designators can be integrated together and can appear on a common portion of the readable resource.

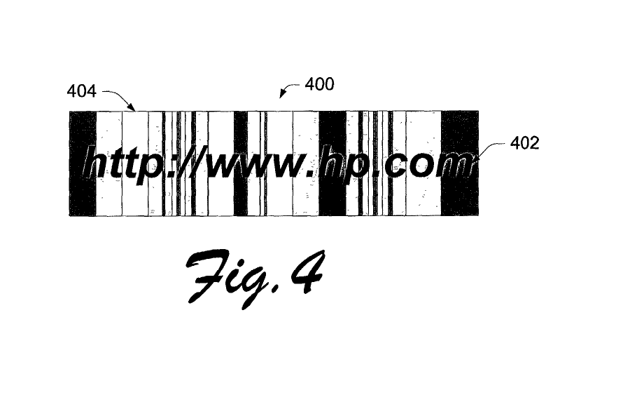

As an example, consider FIG. 4. There, an integrated human-readable/computer-readable resource designator 400 is shown and includes a human-readable resource designator portion 402 provided against a backdrop of a computer-readable resource designator portion 404. The computer-readable resource designator portion 404 can be formed using any suitable structure. In this particular example, the computer-readable resource designator portion 404 is encoded with computer-readable data that is associated with the human-readable resource designator portion 402. Using an integrated designator can help conserve space on a readable resource. Specifically, the area occupied by the computer-readable resource designator portion 404 corresponds to the area consumed by the human-readable resource designator portion 402, plus an additional amount where there is no overlap between the two.

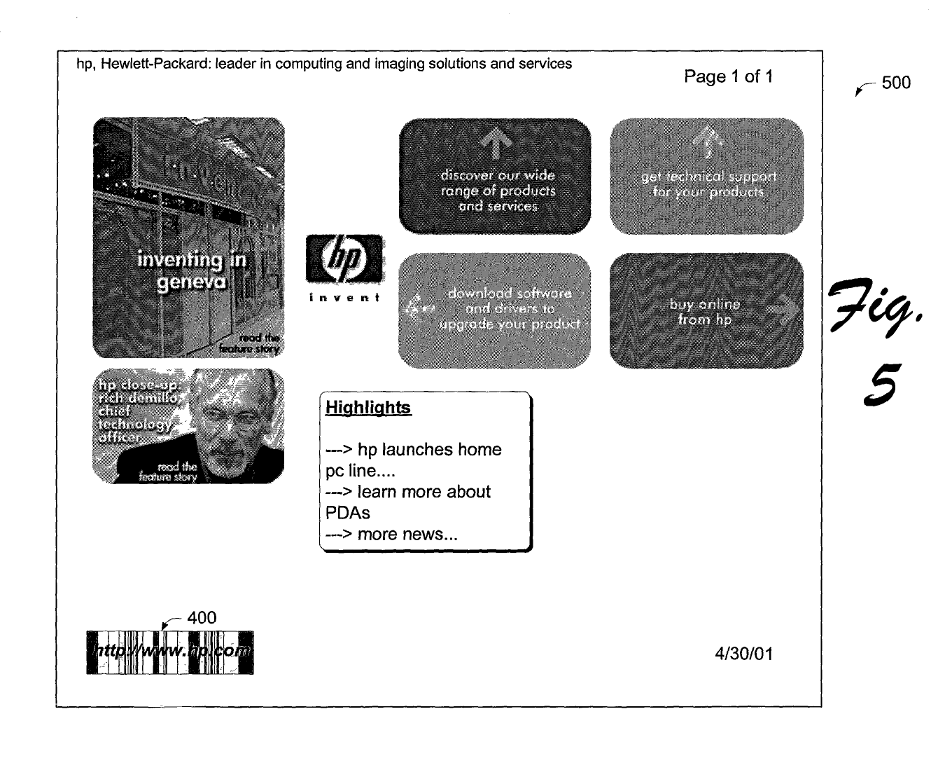

FIG. 5 shows the integrated resource designator 400 in use on a printed Web page 500.

In addition to including an association with its companion human-readable resource designator, the computer-readable resource designator can also encode other information to which it is useful to have access. Specifically, such other data can include revision number, date, access permissions, serial number, security tags and the like. In addition, the integrated resource designator can accommodate different types of characters such as 2-byte Asian type characters.

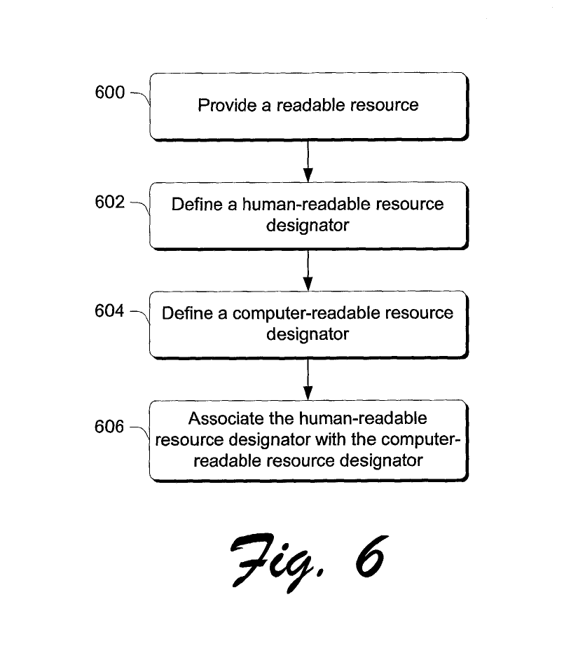

FIG. 6 is a flow diagram that describes steps in a method in accordance with one embodiment. The steps can be implemented manually, or in any suitable hardware, software, firmware, or combination thereof. In the illustrated example, the steps can be implemented in software.

Step 600 provides a readable resource. This step can be implemented in any suitable way. For example, in the Web-based discussion above, this step can be implemented by providing a Web-accessible resource such as a file that is configured for display as a Web page. This step can also be implemented in other ways that do not necessarily require a computer. For example, consider a readable resource in the form of a sign posted by the Forestry Service at the trail head of a hiking trail. The posted sign might contain a brief description of the trail, a map, and perhaps some of the wildlife that might be expected to be seen along the trail. Step 602 defines a human-readable resource designator. Any suitable human-readable resource designator can be used. For example, in the Web-based discussion, the human-readable resource designator can comprise a URL. In the Forestry Service example, this human-readable resource designator can also comprise a URL or some other designator that describes a location where current or additional information can be ascertained. Specifically, in the Forestry Service example, the information that is available on the sign might be of a general, unchanging nature (i.e. trail locations etc.), while the information that is associated with the human-readable resource designator might be associated with information that changes regularly (i.e. weather conditions for that day, closed trails, bear warnings etc.).

Step 604 defines a computer-readable resource designator. Any suitable computer-readable resource designator can be provided, with non-limiting examples being given above. In some embodiments, such as those described above, the computer-readable resource designator can only be read by a computer and not a human to ascertain a URL. Such need not, however, be the case. That is, it is possible for computer-readable resource designator to also be readable by a human in order to ascertain a URL. Step 606 associates the human-readable resource designator with the computer-readable resource designator. Any suitable association can be made. Two exemplary associations were discussed above.

In the Forestry Service example, this association can be made by including the computer-readable resource designator in an area on the sign adjacent the human-readable resource designator and positioned so that a hand-held computing device can easily scan the computer-readable resource designator. By scanning the computer-readable resource designator, the user at the trail head can, with a suitably configured device, access information that is associated with the trail that might be provided in more detail or, perhaps in another more easy-to-understand format. This will become more apparent below.

By having both a human-readable resource designator and a computer-readable resource designator, a user can have an option of how the designator information is input into a device that they might be carrying. Specifically, for users who do not have a scanning mechanism on their device, they can simply enter, by hand, the resource designator gleaned from the sign. For designators that are long strings, as many URLs are, this can be a tedious process further complicated by the small form factor of the hand held device that the user might have. For users whose hand held devices include a scanning device, they can simply scan the computer-readable resource designator into the device in a simple, one-step operation. The device can then use the computer-readable resource designator to access the associated information. Accordingly, the user can conveniently and quickly access current information associated with the human-readable resource designator, without the hassles of having the manually input the human-readable resource designator.

Exemplary System

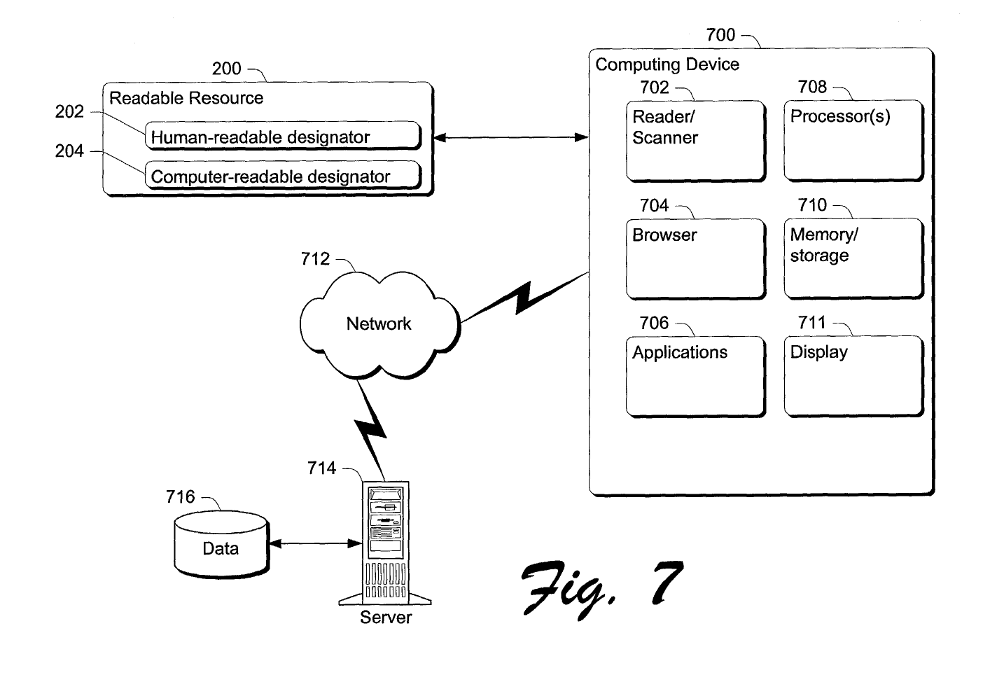

FIG. 7 illustrates an exemplary system in accordance with one embodiment and demonstrates but one way in which various inventive aspects can be employed.

The illustrated system includes a computing device 700 which can be any suitably configured computing device. Various examples of computing devices were given above and include, without limitation, lap top computers, hand held computing devices such as PDAs, and various so-called multi-function printers (MFPs) that typically include not only print functionalities, but other functionalities as well such as scanning, Web browsing and the like. The illustrated computing device can comprise a reader/scanner 702, a Web browser 704, various other software applications generally represented at 706, one or more processors 708, memory or storage 710, and a display 711. Although these components are shown as embodied on one device, it is possible for the components to be provided in a distributed computing environment. For example, the computing device need not necessarily include a browser 704.

Reader/scanner 702 can be any suitable reader or scanner that is capable of reading or scanning computer-readable resource designators such as designator 204. Specific examples can include a bar code scanner and the like. Bar code scanners are known and are not described in additional detail here. For additional information on bar code scanners and the principles upon which they operate, the reader is referred to the following U.S. patents, the disclosures of which are incorporated by reference herein: U.S. Pat. Nos. 6,223,986, 6,220,513, 6,211,990, and 6,138,914.

Web browser 704 can be any suitably configured Web browser. A Web browser is an application program that provides a way to look at and interact with information on the World Wide Web. A Web browser is technically a client program that uses the Hypertext Transfer Protocol to make requests of Web servers throughout the Internet on behalf of the browser user. Examples of commercially available Web browsers include Netscape Navigator and Microsoft's Internet Explorer. The principles upon which Web browsers work are known and are not described in additional detail here.

Applications 706 can comprise any suitable software or firmware applications that can be executed on processor(s) 708. Software applications or application programs are designed to perform specific functions directly for the user or, in some cases, for another application program. Examples of applications can include word processors, database programs, Web browsers, development tools, drawing, paint, image editing programs, and communication programs. Applications use the services of the computer's operating system (also an application) and other supporting applications. The formal requests and means of communicating with other programs that an application program uses is called the application program interface (API).

In the context of this document, the series of steps that are, or can be embodied by one or more application programs are represented in flow diagram form. The steps typically comprise instructions that reside on some type of computer-readable media. It is to be appreciated and understood that aspects of the inventive subject matter described herein extend to all forms of computer-readable media, when that media contain instructions for implementing an application program.

Processors(s) 708 can comprise any suitable microprocessor. Memory/storage 710 can comprise any suitable media that can be used to hold or store data. Memory comprises the electronic holding place for instructions and data that a computer's microprocessor can reach quickly. When a computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in a computer.

Memory is sometimes distinguished from storage, or the physical medium that holds the much larger amounts of data that will not fit into RAM and may not be immediately needed there. Storage devices include hard disks, floppy disks, CD-ROM, and tape backup systems. The terms auxiliary storage, auxiliary memory, and secondary memory have also been used for this kind of data repository. Additional kinds of integrated and quickly accessible memory are read-only memory (ROM), programmable ROM (PROM), and erasable programmable ROM (EPROM). These are used to keep special programs and data, such as the basic input/output system, that the computer uses.

Display 711 can comprise any suitable display. A display typically comprises a computer output surface and projecting mechanism that shows text and often graphic images to the computer user, using a cathode ray tube, liquid crystal display, light-emitting diode, gas plasma, or other image projection technology. The display is usually considered to include the screen or projection surface and the device that produces the information on the screen. In some computers, the display is packaged in a separate unit called a monitor. In other computers, the display is integrated into a unit with the processor and other parts of the computer.

The system of FIG. 7 also includes a network 712 which, in some embodiments comprises the Internet.

The most common topology or general configurations of networks can include the bus, star, and token ring topologies. Networks can also be characterized in terms of spatial distance as local area networks (LANs), metropolitan area networks (MANs), and wide area networks (WANs). A given network can also be characterized by the type of data transmission technology in use on it (for example, a TCP/IP or Systems Network Architecture network); by whether it carries voice, data, or both kinds of signals; by who can use the network (public or private); by the usual nature of its connections (dial-up or switched, dedicated or non-switched, or virtual connections); and by the types of physical links (for example, optical fiber, coaxial cable, and Unshielded Twisted Pair). Large telephone networks and networks using their infrastructure (such as the Internet) have sharing and exchange arrangements with other companies so that larger networks are created.

The illustrated system can also include one or more server computers 714 that are associated with and can access data stored in one or more data stores 716. In general, a server is a computer program that provides services to other computer programs in the same or other computers. The computer that a server program runs in is also frequently referred to as a server (though it may contain a number of server and client programs). In the client/server programming model, a server is a program that awaits and fulfills requests from client programs in the same or other computers. A given application in a computer may function as a client with requests for services from other programs and also as a server of requests from other programs. Specific to the Web, a Web server is the computer program (housed in a computer) that serves requested HTML pages or files. A Web client is the requesting program associated with the user. The Web browser in a computer, such as browser 704 is a client that requests HTML files from Web servers.

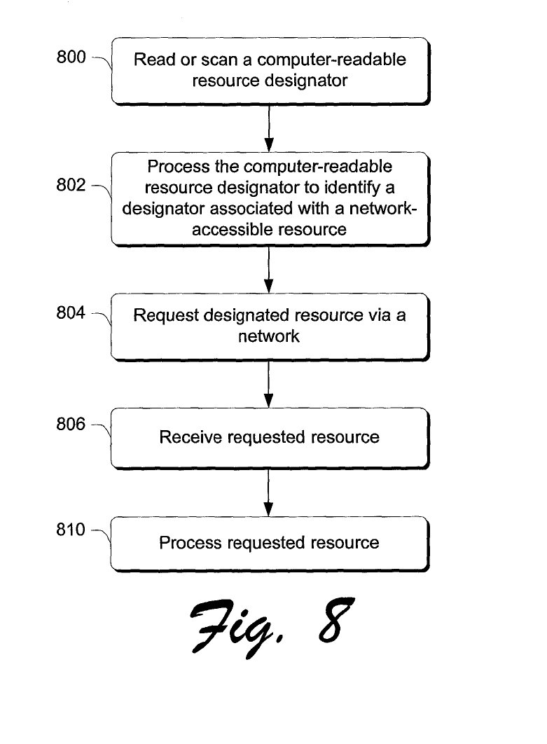

FIG. 8 is a flow diagram that describes steps in a method in accordance with one embodiment. The method can be implemented in any suitable hardware, software, firmware or combination thereof. In the present example, the method can be implemented in software. This software can be embodied on any suitable computer-readable media. In the device of FIG. 7, such software is embodied on device 700.

Step 800 reads or scans a computer-readable resource designator. Examples of computer-readable resource designators are given above. The computer-readable resource designator can be, and preferably is associated with and corresponds to a human-readable resource designator. Both of these designators can be embodied on a readable resource. Examples of different types of readable resources are given above. Step 802 processes the computer-readable resource designator to identify a designator that is associated with a network-accessible resource. In the Web-based example, this step can be implemented by mapping or translating the scanned computer-readable resource designator to an appropriate URL.

Step 804 then requests the designated resource via a network. In some embodiments, the network comprises the Internet, although such need not necessarily be the case. Step 804 can be implemented using any suitable techniques, methods, protocols and the like. On the Internet, there are the TCP/IP protocols that consist of Transmission Control Protocol (TCP), which uses a set of rules to exchange messages with other Internet points at the information packet level and Internet Protocol (IP), which uses a set of rules to send and receive messages at the Internet address level. TCP/IP protocols are known and are not described in additional detail here. Additional protocols that are usually packaged with TCP/IP include the Hypertext Transfer Protocol (HTTP) and File Transfer Protocol (FTP), each with defined sets of rules to use with corresponding programs elsewhere on the Internet.

Step 804's request can be made in a wireless fashion which, in some embodiments, can use the so-called “wireless Web”. The wireless Web refers to use of the World Wide Web through a wireless device, such as a cellular telephone or hand held computing device such as a personal digital assistant (PDA). Wireless Web connections can provide anytime/anywhere connection to e-mail, mobile banking, instant messaging, weather and travel information, and other services (such as the requesting and retrieval of data from server 714). It is estimated that 95% of wireless Internet devices being manufactured today use the Wireless Application Protocol (WAP) developed by Ericsson, Motorola, Nokia, and Unwired Planet (now Phone.com) for presenting content.

WAP (Wireless Application Protocol) is a specification for a set of communication protocol to standardize the way that wireless devices, such as cellular telephones and radio transceivers, can be used for Internet access, including e-mail, the World Wide Web, newsgroups, and Internet Relay Chat (Internet Relay Chat). It is to be appreciated and understood, however, that any suitable wireless protocols can be used.

Step 806 receives the requested resource. This step can be implemented using any suitable techniques, methods, or protocols including those mentioned above. Step 810 processes the requested resource. This step can be implemented with software that is executing on the computerized device and can involve any type of processing. For example, this step can be implemented by automatically processing the requested resource to ensure that it is synchronized with a readable resource that embodies the computer-readable resource designator. Recall that the computer-readable resource designator can be embodied on a printed Web page and that the printed Web page can, over time, become different or obsolete from the resource that originally generated it. This step can also be implemented by processing the requested resource to retrieve a more robust collection of data or information for improving the user experience. As an example, consider the following in the context of the Forestry Service example above. Assume that a user scans in a computer-readable resource designator on a posted sign at the trail head. Assume also that the user's hand held computing device includes audio capabilities and a small speaker. Their computing device can request a resource associated with the computer-readable resource designator. In this example, the requested resource can include one or more audio files that provide a spoken narrative of the history of the trail and a verbal advisory as to current trail conditions.

Exemplary Implementations

The embodiments described above can be used to provide various “E-services”, which are essentially services that are electronically offered, such as those that can be offered over the Internet. Examples can include, without limitation, document tracking of restricted documents, copy prohibitions on secure documents, validation of current document revisions before duplication, copyright/royalty E-services, facilitation of download and printing of original as an option to copying the scanned original.

In addition, the described embodiments can also be useful in connection with various different types of media in addition to paper. Examples include, without limitation, signage, terminals and the like.

Specific exemplary implementations can include ones that are associated with providing assistance to handicapped individuals. For example, for handicapped access, information labels having the designators can be provided on buildings, doors, elevators and the like. The designators can reference an audio source for additional information to assist the handicapped individual.

For translations of signage, a PDA or similar device can scan a sign for a link to provide alternate views and/or languages. Consider the case, for example, of a Japanese hiker who desires very much to hike on a particular trail, but does not read English very well. By using a suitably configured device, they can access, in their native language, additional information such as weather reports and trail advisories which, in turn, provides an added degree of safety.

Yet other embodiments can solve some of the various problems inherent in scanned or copied documents by enabling the user to get directly to the source of the documents.

### CONCLUSION

Various embodiments described above can provide systems and methods for automatically accessing network-accessible resources. Individual embodiments can ensure that a user is presented with current, up-to-date resources. In addition, individual embodiments can automatically provide a user with access to a much more robust collection of information thereby greatly enhancing the user experience.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

I claim:

1. A method comprising:
providing a readable resource;
defining a human-readable resource designator that can be used to access information associated with the readable resource;
defining a computer-readable resource designator that can be used by a computer to automatically access said information; and
associating, on the readable resource, the human-readable resource designator and the computer-readable resource designator.

2. The method of claim 1, wherein said providing comprises providing one or more Web-accessible resources.

3. The method of claim 1, wherein said providing comprises providing one or more resources that are not Web-accessible.

4. The method of claim 1, wherein said defining of the human-readable resource comprises defining a URL.

5. The method of claim 1, wherein said associating comprises printing the designators on a paper.

6. The method of claim 1, wherein said associating comprises printing the designators on a Web page.

7. The method of claim 1, wherein said associating comprises placing the designators on a media other than printed paper.

8. The method of claim 1, wherein said defining a computer-readable resource designator comprises defining a designator that is not human-readable for purpose of accessing said information.

9. One or more computer-readable media having computer-readable instructions thereon which, when executed by one or more processors, cause the one or more processors to:
define a human-readable resource designator comprising a URL that can be used to access a Web page;
define a computer-readable resource designator associated with and corresponding to the URL that can be used by a computer to automatically access said Web page; and
associate the human-readable resource designator with the computer-readable resource designator in a manner such that if the Web page is printed, individual designators appear thereon.

10. The computer-readable media of claim 9, wherein said instructions cause the one or more processors to define different designators.

11. The computer-readable media of claim 9, wherein said instructions cause the one or more processors to define an integrated designator that includes both a human-readable portion and a computer-readable portion.

12. The computer-readable media of claim 9, wherein said instructions cause the one or more processors to define said computer-readable resource designator by defining said designator so that it is only readable by a computer to ascertain the URL, and is not readable a human to ascertain the URL.

13. The computer-readable media of claim 9, wherein said instructions cause the one or more processors to define said computer-readable resource designator by defining a plurality of scan lines.

14. A method comprising:
reading, with a computer, a computer-readable resource designator that can be used by a computer to automatically access information, said computer-readable resource designator being displayed on a readable resource and displayed in conjunction with a human-readable resource designator that can be read by a human and used to access said information;
processing the computer-readable resource designator to identify a designator that is associated with a network-accessible resource;
requesting a designated resource; and
receiving the requested resource.

15. The method of claim 14, wherein said computer-readable resource designator is associated with a human-readable resource designator comprising a URL.

16. The method of claim 14, wherein said requesting comprises wirelessly requesting said designated resource.

17. The method of claim 14, wherein said requesting comprises requesting said designated resource over the Internet.

18. The method of claim 14, wherein said reading comprises reading a computer-readable resource designator that is embodied on a printed piece of paper.

19. The method of claim 14, wherein said reading comprises reading a computer-readable resource designator that is embodied on a printed Web page.

20. A system comprising:
a readable resource;
a human-readable resource designator on the readable resource; and
a computer-readable resource designator on the readable resource;
the computer-readable resource designator being associated with and corresponding to the human-readable resource designator;
the computer-readable resource designator being configured for use by a computer so that a computer can automatically retrieve a resource associated with both the human-readable resource designator and the computer-readable resource designator.

21. The system of claim 20, wherein said computer-readable resource designator comprises a scannable designator.

22. The system of claim 20, wherein said computer-readable resource designator comprises plural scan lines.

23. The system of claim 20, wherein said computer-readable resource designator comprises a bar code.

24. The system of claim 20, wherein said human-readable resource designator comprises a URL.

25. The system of claim 20, wherein said readable resource comprises a printed piece of paper.

26. The system of claim 20, wherein said readable resource comprises a printed Web page.

27. The system of claim 20, wherein said readable resource comprises a media other than paper.

28. The system of claim 20, wherein said computer-readable resource designator and said human-readable resource designator are integrated.

29. The system of claim 20, wherein said computer-readable resource designator and said human-readable resource designator are integrated and appear on a common portion of the readable resource.

30. A system comprising:
at least one human-readable resource designator; and
at least one computer-readable resource designator associated with and corresponding to said one human-readable resource designator, the computer-readable resource designator being configured for use by a computer so that a computer can automatically retrieve a resource associated with both the human-readable resource designator and the computer-readable resource designator.

31. The system of claim 30, wherein said at least one computer-readable resource designator comprises a scannable designator.

32. The system of claim 30, wherein said at least one computer-readable resource designator comprises plural scan lines.

33. The system of claim 30, wherein said at least one computer-readable resource designator comprises a bar code.

34. The system of claim 30, wherein said at least one human-readable resource designator comprises a URL.

35. A system comprising:
one or more readable resources each of which comprising a human-readable resource designator and a computer-readable resource designator associated with and corresponding to the human-readable resource designator;
the computer-readable resource designator being configured for use by a computer so that a computer can automatically retrieve a resource associated with both the human-readable resource designator and the computer-readable resource designator;
one or more servers configured to receive requests for resources associated with both the human-readable resource designator and the computer-readable resource designator, and return requested resources to one or more computing devices; and
a data store for holding resources that can be requested by one or more computing devices.

36. The system of claim 35, wherein the human-readable resource designator comprises a URL.

37. The system of claim 35, wherein the readable resource comprises a printed piece of paper.

38. The system of claim 35, wherein the readable resource comprises a printed Web page.

39. The system of claim 35, wherein the readable resource comprises a media other than paper.

40. The system of claim 35 further comprising one or more computing devices configured to read computer-readable resource designators and request resources associated with individual computer-readable resource designators.
